(19) United States
(12) Patent Application Publication
(10) Pub. No.: US 2025/0354848 A1
(43) Pub. Date: Nov. 20, 2025

(54) DISPENSER

(71) Applicant: Miaomada Co., Ltd., Tokyo (JP)

(72) Inventor: Naoyuki YODA, Tokyo (JP)

(73) Assignee: Miaomada Co., Ltd., Tokyo (JP)

(21) Appl. No.: 19/016,673

(22) Filed: Jan. 10, 2025

(30) Foreign Application Priority Data
May 14, 2024 (JP) 2024-079033

(51) Int. Cl. G01F 11/24; G01F 11/00

(52) U.S. Cl. CPC G01F 11/24; G01F 11/006

(57) ABSTRACT

A case is provided below a storage container and includes a ring-shaped recessed portion. An accommodating portion includes an accommodating cylinder that is movable within the ring-shaped recessed portion with a rotational force applied from a handle, in which when the accommodating cylinder moves to an introduction section, powder is introduced through an upper end opening and when the accommodating cylinder moves to a dispensing position, the powder introduced is dispensed via a lower end opening.

### CROSS REFERENCE TO RELATED APPLICATION

This application claims the benefit of priority to Japanese Patent Application No. 2024-079033 filed on May 14, 2024 with the Japanese Patent Office, the entire contents of which are incorporated herein by this reference.

### FIELD OF THE INVENTION

The present invention relates to a dispenser.

### BACKGROUND

Conventionally, there has been a dispenser capable of dispensing powder stored in a storage container by a predetermined amount.

For example, U.S. Pat. No. 9,587,972 discloses a dispenser in which a case (base 10) is provided below a storage container that stores powdered dry food, a slidable handle (12) is provided so as to project in a circumferential direction from a window (19) provided on a circumferential wall (13) of the case (base 10), a pair of lower opening cells (26a, 26b) provided inside the case (base 10) are slidable in the circumferential direction with an operation of the handle (12) by a user, and when dry food is temporarily accommodated in one lower opening cell, the dry food temporarily accommodated in the other lower opening cell is dispensed through a dispensing aperture (15) and when the dry food accommodated in one lower opening cell is dispensed through the dispensing aperture (15), the dry food is temporarily accommodated in the other lower opening cell.

### SUMMARY

A dispenser according to an embodiment includes a case, an accommodating portion, and an inner lid. The case includes a ring-shaped recessed portion provided below a storage container that stores powder and a dispensing aperture provided in the ring-shaped recessed portion. The accommodating portion includes an accommodating cylinder that has an upper end opening and a lower end opening and that is movable within the ring-shaped recessed portion with a rotational force applied from a handle, in which when the accommodating cylinder moves to an introduction section, the powder is introduced through the upper end opening, and when the accommodating cylinder moves to a dispensing position, the lower end opening communicates with the dispensing aperture to dispense the introduced powder through the lower end opening. The inner lid is fixed to an upper portion of the ring-shaped recessed portion and includes a cover plate that covers at least the upper end opening of the accommodating cylinder located in the dispensing position and an opening portion that is adjacent to the cover plate and that opens the upper portion of the ring-shaped recessed portion in the introduction section.

### BRIEF DESCRIPTION OF THE DRAWINGS

FIG. 1 is a perspective view showing an example of the overall structure of a dispenser according to an embodiment;

FIG. 2 is an exploded view showing an example of the overall structure of the dispenser according to the embodiment;

FIG. 3 is a perspective view showing an example of an axis body portion being attached to a case of the dispenser according to the embodiment;

FIG. 4 is a top view showing an example of the structure of the axis body portion of the dispenser according to the embodiment;

FIG. 5 is a perspective view showing an example of the structure of the axis body portion of the dispenser according to the embodiment;

FIG. 6 is a lower perspective view showing an example of the structure of an accommodating portion of the dispenser according to the embodiment;

FIG. 7 is a central cross-sectional view showing an example of the structure of the accommodating portion of the dispenser according to the embodiment;

FIG. 8 is a top view showing an example of attachment of an inner lid of the dispenser according to the embodiment; and

FIG. 9 is a top view showing an example of attachment of an agitator of the dispenser according to the embodiment.

### DETAILED DESCRIPTION OF THE PREFERRED EMBODIMENT

Hereinafter with reference to the drawings, an embodiment will be described. In the description of the embodiment, the gravity direction is a downward direction and a direction opposite to the gravity direction is an upward direction.

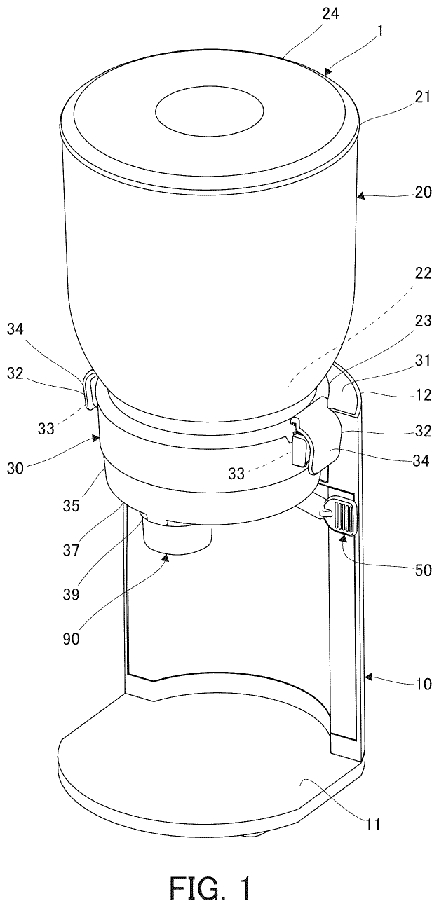

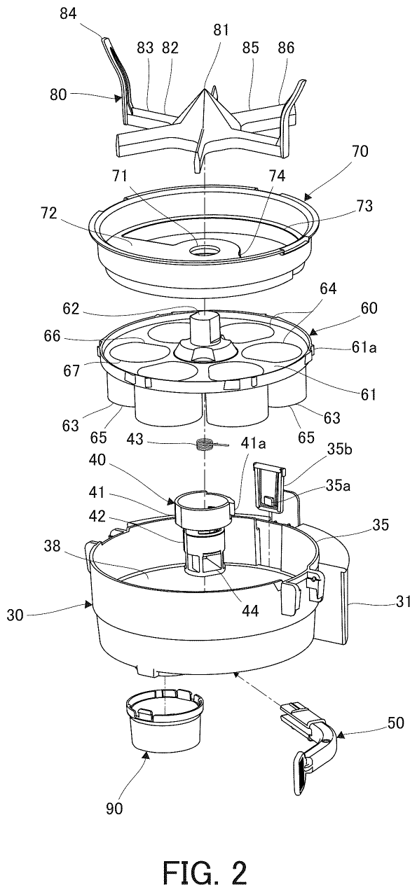

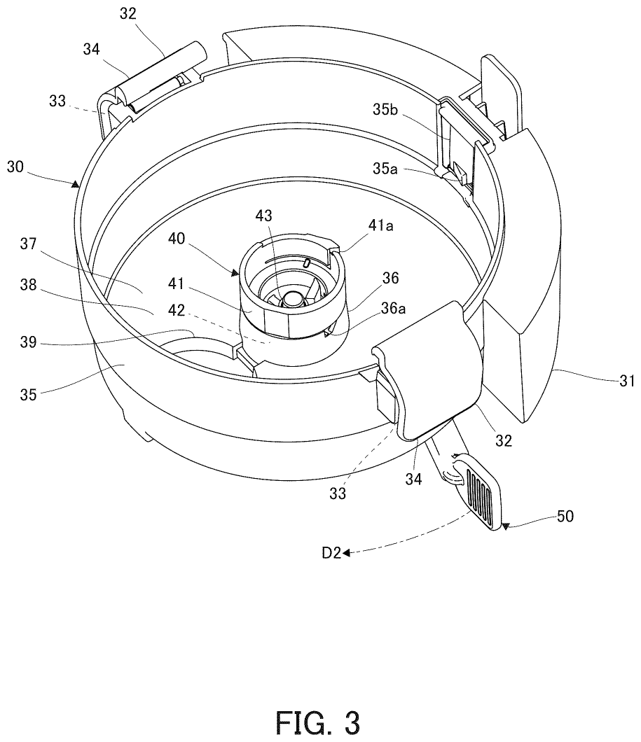

FIG. 1 and FIG. 2 are views showing an example of the overall structure. FIG. 1 is a perspective view and FIG. 2 is an exploded view. FIG. 3 is a perspective view showing an example of an axis body portion 40 being attached to a case 30.

As shown in FIG. 1 and FIG. 2, a dispenser 1 stores powder such as protein powder in a storage container 20 and is capable of dispensing the stored powder by a predetermined amount. The dispenser 1 includes a stand 10, the storage container 20, the case 30, the axis body portion 40, a handle 50, an accommodating portion 60, an inner lid 70, an agitator 80, and a nozzle 90.

The stand 10 includes a base 11 that allows a dispensing container receiving dispensed powder to be mounted thereon, and a support portion 12 that stands on a rear side of the base 11 and that supports the case 30 above the base 11.

The storage container 20 may be made of material such as a transparent resin so as to allow a user to visually recognize the powder stored inside. The storage container 20 has a cylinder shape and is provided with, at its upper portion, an input port 21 through which powder can be input, at its lower portion, a communication port 22 communicating with the case 30 and adapted to introduce the powder into the case 30, and on an outer circumference of its lower portion, a flange 23. An upper lid 24 is detachably attached to the input port 21, and the user can remove the upper lid 24 and input powder into the storage container 20 and attach the upper lid 24 after the input.

The case 30 is provided with, on its rear side, a fitting portion 31 to be fitted to the support portion 12, and is supported on the support portion 12 by means of the fitting portion 31.

The case 30 is provided with a latch mechanism 32 for fixing the storage container 20 to an upper portion thereof. The latch mechanism 32 is provided at positions opposing each other on an outer circumference of the case 30, and includes a coupling plate 33 swingably coupled to the case 30 and a hook 34 swingably coupled to the coupling plate 33. When a user engages the hook 34 with the flange 23 provided in the lower portion of the storage container 20 and pushes the hook 34 to the inner side with the coupling plate 33 folded to the inner side, the latch mechanism 32 is locked to fix the storage container 20 to the upper portion of the case 30. Further, when the user disengages the hook 34 from the case 30, the latch mechanism 32 is unlocked to allow the storage container 20 to be removed from the case 30.

As shown in FIG. 3, the case 30 includes a ring-shaped recessed portion 38 that is provided below the storage container 20 and surrounded by an outer cylinder 35, an inner cylinder 36, and a bottom 37. On an inner circumferential surface of the outer cylinder 35, a plate 35b having an outer ratchet 35a to engage a locking projection 61a described later is fitted. At an upper end of the inner cylinder 36, a notch 36a for locking one end portion of a torsion spring described later is provided.

The bottom 37 is provided with a dispensing aperture 39 for dispensing powder.

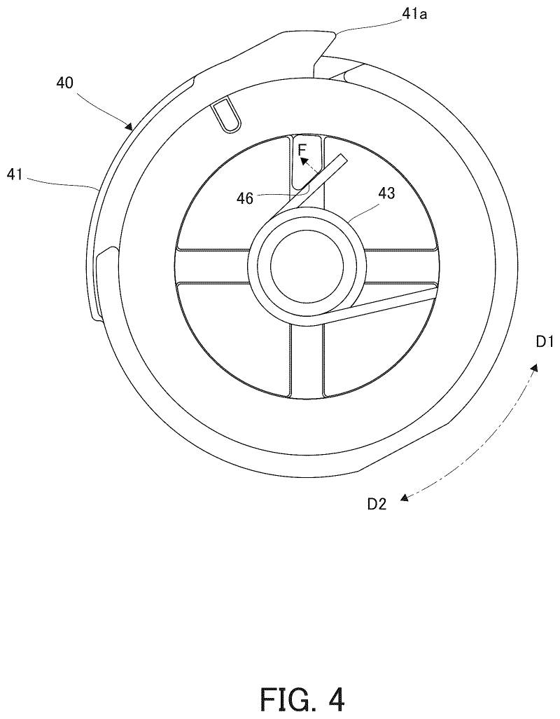

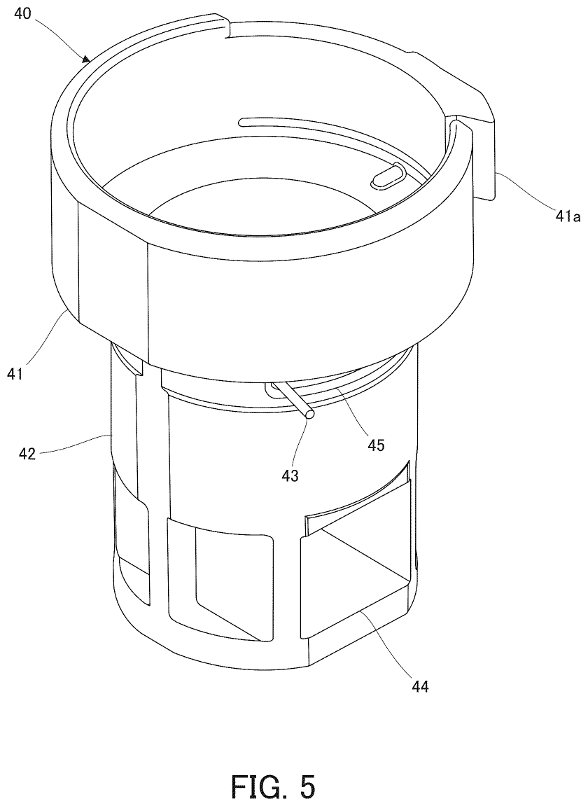

FIG. 4 and FIG. 5 are views showing an example of the structure of the axis body portion 40. FIG. 4 is a top view and FIG. 5 is a perspective view.

The axis body portion 40 is supported on the inner cylinder 36 and a rotational force is applied thereto from the handle 50 attached to a lower side of the case 30. More specifically, as shown in FIG. 4 and FIG. 5, the axis body portion 40 includes a head portion 41, a body portion 42, and an elastic member 43. The head portion 41 includes an inner side ratchet 41a on a circumferential surface, and a lower surface of a circumferential edge portion thereof is supported at the upper end of the inner cylinder 36. The body portion 42 is provided so as to be continuous with a lower side of the head portion 41, has a smaller diameter than the head portion 41, is freely fitted into the inner cylinder 36, and has a handle attachment hole 44 provided on a lower side so as to project below the bottom 37 of the case 30. The elastic member 43 is, for example, a torsion spring provided inside the head portion 41 or the body portion 42, with one side portion projecting from a long hole 45 provided on a circumferential wall in a circumferential direction to be fixed to the notch 36a of the inner cylinder 36 and with the other side portion fixed to a fixing portion 46 on an inner side, and applies an urging force F to the axis body portion 40 to cause it to rotate in a first circumferential direction D1.

With the rotational force applied from the handle 50 attached to the handle attachment hole 44, the axis body portion 40 is rotatable by a predetermined rotating angle in a second circumferential direction D2 opposite to the first circumferential direction D1, against the urging force F of the elastic member 43. When the axis body portion 40 rotates in the second circumferential direction D2, one side portion of the torsion spring fixed to the notch 36a moves within the long hole 45 in the circumferential direction. The position and the length of the long hole 45 are adjusted in accordance with a predetermined rotating angle, a predetermined rotating start position, and a predetermined rotating end position of the axis body portion 40. The predetermined rotating angle is adjusted to, for example, 60 degrees at which six accommodating cylinders 63 provided in the circumferential direction rotate by one position, and the predetermined rotating start position and the predetermined rotating end position are adjusted to positions where the accommodating cylinders 63 move by one position.

When the rotational force toward the second circumferential direction D2 by the handle 50 is cancelled, the axis body portion 40 rotates in the first circumferential direction D1 with the urging force F to return the handle 50 to an initial position.

The first circumferential direction D1 is, for example, a counter-clockwise direction when viewed from above and the second circumferential direction D2 is a clockwise direction when viewed from above.

In accordance with the user's preference, the handle 50 can be attached so as to be fitted from one side of the handle attachment hole 44 and disposed in the first circumferential direction D1 relative to the nozzle 90, or can be attached so as to be fitted from the other side of the handle attachment hole 44 and disposed in the second circumferential direction D2 relative to the nozzle 90. In the example of FIG. 1, the handle 50 is attached so as to be disposed in the first circumferential direction D1 relative to the nozzle 90.

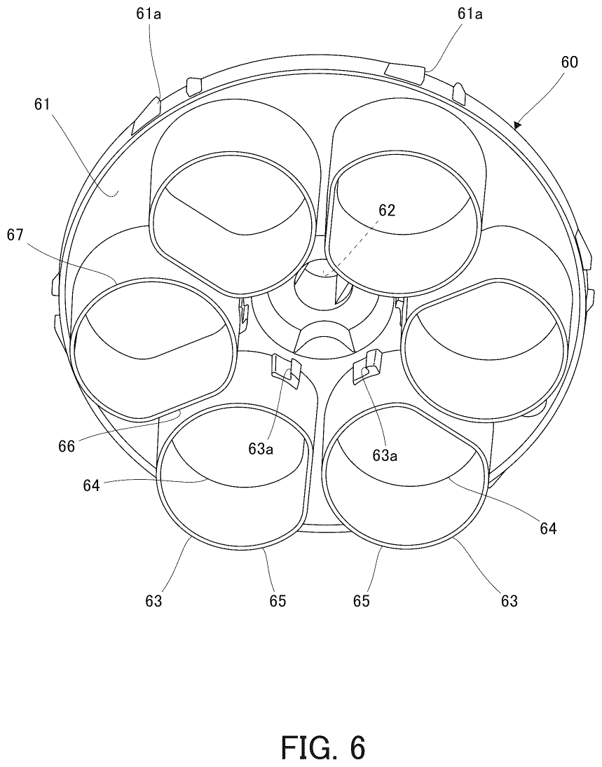

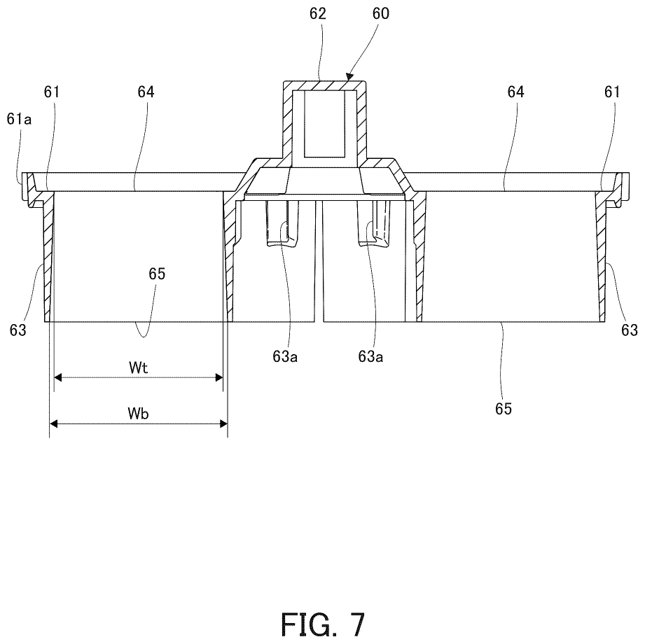

FIG. 6 and FIG. 7 show an example of the structure of the accommodating portion 60. FIG. 6 is a lower perspective view and FIG. 7 is a central cross-sectional view.

As shown in FIG. 6, the accommodating portion 60 includes a disk portion 61 adhering to the axis body portion 40 and rotatable in the circumferential direction with the rotational force applied from the axis body portion 40. A center of the disk portion 61 is provided with a center projecting portion 62 that transmits the rotational force received from the axis body portion 40 to the agitator 80. The six accommodating cylinders 63 arranged with a distance from each other in the circumferential direction are provided around the center projecting portion 62.

The accommodating cylinder 63 includes an upper end opening 64 that opens in the disk portion 61 and a lower end opening 65 that slides on the bottom 37, and is movable within the ring-shaped recessed portion 38, with the rotational force applied from the axis body portion 40. When the accommodating cylinder 63 moves to an introduction section described later, powder is introduced thereinto through the upper end opening 64 and when the accommodating cylinder 63 moves to a dispensing position, the lower end opening 65 communicates with the dispensing aperture 39 to dispense the introduced powder via the lower end opening 65.

The upper end opening 64 and the lower end opening 65 of the accommodating cylinder 63 each include a linear edge portion 66 in a linear shape formed by shifting a side in the second circumferential direction D2 toward the inner side so as to more surely drop the powder to the dispensing aperture 39 even when the position of the accommodating cylinder 63 is deviated from the position of the dispensing aperture 39 toward the second circumferential direction D2, and a recessed curve-shaped edge portion 67 on the first circumferential direction D1 side.

As shown in FIG. 7, to be able to reduce friction with the inner circumferential surface when the powder flows out from the dispensing aperture 39, the accommodating cylinder 63 has an inner width in a direction orthogonal to an extending direction gradually increased from the upper end opening 64 toward the lower end opening 65, with a lower end opening inner width Wb greater than an upper end opening inner width Wt and with an opening area of the lower end opening 65 greater than that of the upper end opening 64.

An outer circumference of the disk portion 61 is provided with the locking projection 61a where the outer ratchet 35a is locked. The circumferential surface of the accommodating cylinder 63 is provided with an engagement portion 63a that engages the inner side ratchet 41a. When the axis body portion 40 rotates in the second circumferential direction D2, the engagement portion 63a that the inner side ratchet 41a provided on the circumferential surface of the head portion 41 engages is pressed and moved, so that the accommodating portion 60 rotates in the second circumferential direction D2. Meanwhile, when the axis body portion 40 rotates in the first circumferential direction D1, the outer ratchet 35a locks the locking projection 61a to inhibit the rotation of the accommodating portion 60 in the first circumferential direction D1. In this manner, when a user causes, by fingers, the handle 50 to swing in the second circumferential direction D2 by a predetermined rotating angle, the accommodating portion 60 rotates in the second circumferential direction D2. When the user releases the fingers from the handle 50, with the urging force F of the elastic member 43, the axis body portion 40 rotates in the first circumferential direction D1 to return to an original position, but the outer ratchet 35a locks the locking projection 61a to inhibit the rotation of the accommodating portion 60 in one direction. Thus, when the handle 50 reciprocates once in the circumferential direction, the accommodating portion 60 rotates in the second circumferential direction D2 by a predetermined rotating angle.

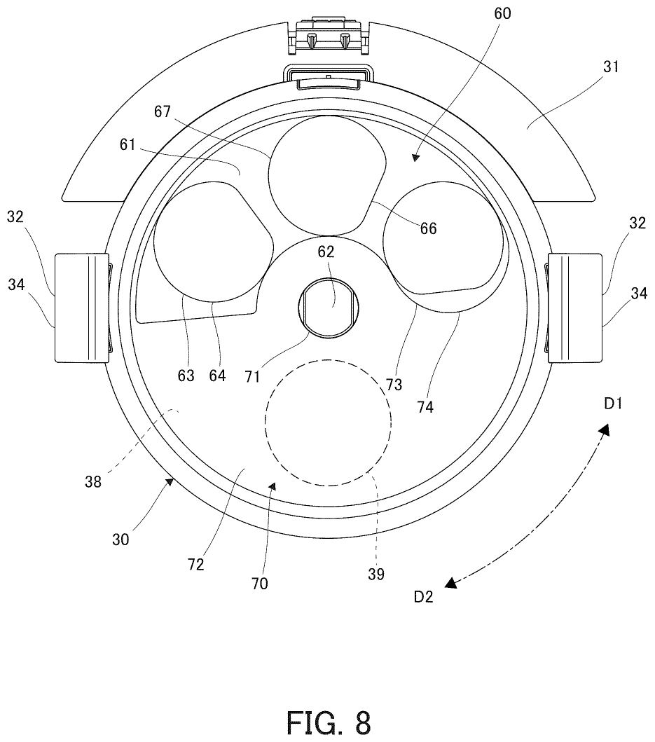

FIG. 8 is a top view showing an example of attachment of the inner lid 70.

As shown in FIG. 8, the inner lid 70 is fixed to an upper portion of the ring-shaped recessed portion 38 and a center hole 71 is externally fitted around the center projecting portion 62. The inner lid 70 includes a cover plate 72 and an opening portion 73 adjacent to the cover plate 72. The cover plate 72 extends in at least a position corresponding to the dispensing position of the accommodating cylinder 63 and covers the upper end opening 64 of at least the accommodating cylinder 63 located in the dispensing position. It is preferable that the cover plate 72 extend in the position corresponding to the accommodating cylinders 63 arranged on both sides in the circumferential direction in the dispensing position and cover the upper end openings 64 of the accommodating cylinders 63 arranged next to the accommodating cylinder 63 located in the dispensing position. As a more specific example, when six accommodating cylinders 63 are arranged in the circumferential direction, three of the accommodating cylinders 63 are covered by having the dispensing aperture 39 as a center.

The opening portion 73 is adjacent to the cover plate 72 and opens the upper portion of the ring-shaped recessed portion 38. The opening portion 73 forms an introduction section that introduces powder from the storage container 20 into the accommodating cylinder 63. The powder is introduced into the accommodating cylinder 63 from the storage container 20 via the opening portion 73 in the introduction section with the gravity.

An edge facing the opening portion 73 of the cover plate 72 is provided with a scraping portion 74, which has a predetermined height by extending the edge in a downward direction and has a deflating shape with an inner width reduced toward the rotating direction (second circumferential direction D2) of the accommodating portion 60. The scraping portion 74 performs scraping of the upper end opening 64 of the accommodating cylinder 63 that passes underneath.

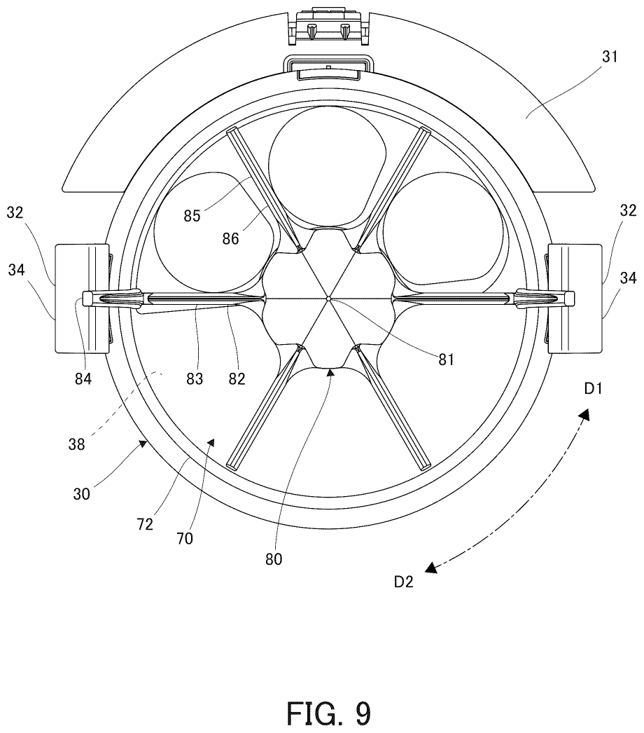

FIG. 9 is a top view showing an example of attachment of the agitator 80.

As shown in FIG. 9, the agitator 80 includes a center portion 81 that receives transmission of a rotational force from the center projecting portion 62 inserted through the center hole 71 and a first agitating vane 82 extending from the center portion 81 outwardly in a radial direction and disposed along an inner surface of the storage container 20. More specifically, the first agitating vane 82 includes a first horizontal agitating portion 83 horizontally, outwardly extending in the radial direction from the center portion 81 and an upper agitating portion 84 extending upwardly along the inner surface of the storage container 20 from an extending end of the first horizontal agitating portion 83.

Further, the agitator 80 includes a second agitating vane 85 thicker in width and shorter than the first agitating vane 82. More specifically, the second agitating vane 85 includes a second horizontal agitating portion 86 horizontally, outwardly extending in the radial direction from the center portion 81. Two first agitating vanes 82 and four second agitating vanes 85, six agitating vanes in total, are each disposed between the accommodating cylinders 63 that are adjacent to each other.

Returning to FIG. 1, the nozzle 90 is detachably attached to the dispensing aperture 39 provided on a lower side of the case 30. A lower end of the nozzle 90 is disposed near an opening of the dispensing container to avoid scattering of the powder when the powder enters the container. The nozzle 90 is replaceable with those having a length corresponding to the height of the dispensing container.

### (Functions)

According to the embodiment, the following functions and effects are produced.

(A) The dispenser 1 includes the axis body portion 40 to which the rotational force is applied from the handle 50 provided below the case 30 and the accommodating cylinder 63 that is movable about the axis within the ring-shaped recessed portion 38, with the rotational force applied from the axis body portion 40. Therefore, the powder inside the case 30 is unlikely to leak to the outside of the ring-shaped recessed portion 38, and since the lower end of the nozzle 90 is disposed near the opening of the dispensing container, the powder is unlikely to be scattered when dispensed, thereby making it possible to avoid the surroundings from becoming dirty.
(B) The inner lid 70 is fixed to the upper portion of the ring-shaped recessed portion 38 and includes the cover plate 72 that covers at least the upper end opening 64 of the accommodating cylinder 63 located in the dispensing position, and the opening portion 73 that is adjacent to the cover plate 72 and that opens the upper portion of the ring-shaped recessed portion 38. In the dispenser 1, the opening portion 73 is elongated in the circumferential direction so that the introduction section where the powder is introduced into the accommodating cylinder 63 from the storage container 20 can be made longer, thereby enabling more surely introducing a sufficient amount of powder into the accommodating cylinder 63, suppressing generation of a bridge or a rathole, and stably dispensing the predetermined amount of powder.
(C) The axis body portion 40 includes the elastic member 43 that applies the urging force F to rotate the axis body portion 40 in the first circumferential direction D1, and when a user releases the hand from the handle 50 after moving the handle 50 in the second circumferential direction D2, the handle 50 returns to the initial position, and the operation is simple.
(D) When the handle 50 reciprocates once in the circumferential direction, the accommodating portion 60 rotates by a predetermined rotating angle in the second circumferential direction D2. In this manner, a rotating angle of the handle 50 can be reduced so that the handle 50 can be prevented from contacting the nozzle 90 attached to the lower side of the case 30.
(E) The scraping portion 74 performs scraping of the accommodating cylinder 63 to make the amount of powder accommodated in the accommodating cylinders 63 to be more uniform.
(F) The agitator 80 includes the first agitating vane 82 extending from the center portion 81 outwardly in the radial direction and disposed along the inner surface of the storage container 20, and the second agitating vane 85 thicker in width and shorter than the first agitating vane 82. The agitator 80 receives transmission of the rotational force from the center projecting portion 62 to rotate in the second circumferential direction D2 and the second agitating vane 85 shorter than the first agitating vane 82 is made thicker in width, so that the agitating force generated by each of the first agitating vane 82 and the second agitating vane 85 is aligned so as to agitate the powder in a more well-balanced manner and drop the powder in a more uniform amount to each of the accommodating cylinders 63 from the opening portion 73.
(G) The first agitating vane 82 includes the first horizontal agitating portion 83 horizontally, outwardly extending in the radial direction from the center portion 81 and the upper agitating portion 84 extending upwardly along the inner surface of the storage container 20 from the extending end of the first horizontal agitating portion 83. In this manner, adhesion of the powder to the inner circumferential surface of the storage container 20 is suppressed and generation of a bridge or a rathole is suppressed.
(H) In the dispenser 1, the operation is simple in that the handle 50 is disposed so as to be adjacent to the nozzle 90 below the case 30 and the motion of operating the handle by a hand after placing the container on the base 11 is minimal.
(I) In the dispenser 1, the stand 10, the storage container 20, the case 30, the axis body portion 40, the handle 50, the accommodating portion 60, the inner lid 70, the agitator 80, and the nozzle 90 can be easily disassembled and are easily cleaned.
(J) The accommodating cylinder 63 has the inner width increased from the upper end opening 64 toward the lower end opening 65. Therefore, when the powder flows out from the dispensing aperture 39 with the gravity, the friction with the inner circumferential surface can be reduced so as to enable the powder to be smoothly discharged.

That is, the dispenser 1 includes: the case 30 including the ring-shaped recessed portion 38 that is provided below the storage container 20 that stores powder and surrounded by the outer cylinder 35, the inner cylinder 36, and the bottom 37, and the dispensing aperture 39 provided in the ring-shaped recessed portion 38; the axis body portion 40 that is supported on the inner cylinder 36 and the rotational force is applied thereto from the handle 50 provided below the case 30; the accommodating portion 60 including the accommodating cylinder 63 that has the upper end opening 64 and the lower end opening 65 and that is movable within the ring-shaped recessed portion 38 with the rotational force applied from the axis body portion 40, in which when the accommodating cylinder 63 moves to the introduction section, the powder is introduced through the upper end opening 64, and when the accommodating cylinder 63 moves to the dispensing position, the lower end opening 65 communicates with the dispensing aperture 39 to dispense the introduced powder through the lower end opening 65; and the inner lid 70 fixed to the upper portion of the ring-shaped recessed portion 38 and including the cover plate 72 that covers at least the upper end opening 64 of the accommodating cylinder 63 located in the dispensing position and the opening portion 73 that is adjacent to the cover plate 72 and that opens the upper portion of the ring-shaped recessed portion 38 in the introduction section.

The axis body portion 40 includes: the head portion 41 that engages the upper end of the inner cylinder 36 and that has the inner side ratchet 41a on the outer circumference; the body portion 42 that is provided so as to be continuous with the lower side of the head portion 41 and that is freely fitted into the inner cylinder 36 and the handle 50 is attached thereto; and the elastic member 43 that is locked in the inner cylinder 36 and that applies the urging force F to rotate the axis body portion 40 in the first circumferential direction D1, and is rotatable in the second circumferential direction D2 opposite to the first circumferential direction D1, against the urging force F of the elastic member 43 due to the rotational force applied from the handle 50.

The scraping portion 74 is provided at the edge facing the opening portion 73 of the cover plate 72 and performs scraping of the upper end opening 64 of the accommodating cylinder 63.

The scraping portion 74 is provided so as to have a predetermined height by extending the edge facing the opening portion 73 of the cover plate 72 in the downward direction and has a deflating shape with the inner width reduced toward the rotating direction of the accommodating portion 63.

The agitator 80 includes the center portion 81 that receives transmission of the rotational force from the axis body portion 40, the first agitating vane 82 extending from the center portion 81 outwardly in the radial direction and disposed along the inner surface of the storage container 20, and the second agitating vane 85 thicker in width and shorter than the first agitating vane 82.

The first agitating vane 82 includes the first horizontal agitating portion 83 horizontally, outwardly extending in the radial direction from the center portion 81 and the upper agitating portion 84 extending upwardly along the inner surface of the storage container 20 from an outer end of the first horizontal agitating portion 83. The second agitating vane 85 includes the second horizontal agitating portion 86 horizontally, outwardly extending in the radial direction from the center portion 81.

The inner width of the accommodating cylinder 63 in the direction orthogonal to the extending direction increases from the upper end opening 64 toward the lower end opening 65.

According to the embodiment, the dispenser 1 can be used with a clean condition and allows the powder in a stable amount to be dispensed.

As described above, the embodiment of the present invention has been described, but the embodiment is not limited thereto, various changes, modifications, and the like are available within the scope without changing the gist of the present invention.

For example, in the embodiment, the example of protein powder as the powder has been described, but the powder is not limited thereto. The powder may be flour, salt, sugar, coco powder, and the like, or any other powder.

Further, in the embodiment, the example has been described in which the disk portion 61 is provided with six accommodating cylinders 63 in the circumferential direction, but the number of the accommodating cylinders 63 is not limited to six. The number of the accommodating cylinders 63 may be less than six or 7 or greater.

Furthermore, in the embodiment, the example has been described in which the first circumferential direction D1 is the counter-clockwise direction when viewed from above and the second circumferential direction D2 is the clockwise direction when viewed from above, but the first circumferential direction D1 may be the clockwise direction and the second circumferential direction D2 may be the counter-clockwise direction.

What is claimed is:

1. A dispenser comprising:
a case including a ring-shaped recessed portion provided below a storage container that stores powder and a dispensing aperture provided in the ring-shaped recessed portion;
an accommodating portion including an accommodating cylinder, the accommodating cylinder having an upper end opening and a lower end opening, the accommodating cylinder being movable within the ring-shaped recessed portion with a rotational force applied from a handle, wherein when the accommodating cylinder moves to an introduction section, the powder is introduced through the upper end opening and when the accommodating cylinder moves to a dispensing position, the lower end opening communicates with the dispensing aperture so that the powder introduced is dispensed via the lower end opening; and
an inner lid fixed to an upper portion of the ring-shaped recessed portion, the inner lid including a cover plate that covers at least the upper end opening of the accommodating cylinder that is located in the dispensing position, and an opening portion that is adjacent to the cover plate and that opens the upper portion of the ring-shaped recessed portion in the introduction section.

2. The dispenser according to claim 1, comprising an axis body portion, wherein
the ring-shaped recessed portion is surrounded by an outer cylinder, an inner cylinder, and a bottom,
the axis body portion is supported on the inner cylinder and a rotational force is applied to the axis body portion from the handle provided below the case, and
the accommodating portion includes the accommodating cylinder, the accommodating cylinder having the upper end opening and the lower end opening, the accommodating cylinder being movable within the ring-shaped recessed portion with a rotational force applied from the axis body portion, wherein when the accommodating cylinder moves to the introduction section, the powder is introduced through the upper end opening and when the accommodating cylinder moves to the dispensing position, the lower end opening communicates with the dispensing aperture so that the powder introduced is dispensed via the lower end opening.

3. The dispenser according to claim 2, wherein
the axis body portion comprises:
a head portion engaging an upper end of the inner cylinder and including an inner side ratchet on an outer circumference;
a body portion provided so as to be continuous with a lower side of the head portion and freely fitted into the inner cylinder, the handle being attached to the body portion; and
an elastic member locked in the inner cylinder and configured to apply an urging force in a first circumferential direction, and
the axis body portion is rotatable in a second circumferential direction opposite to the first circumferential direction against the urging force of the elastic member due to the rotational force applied from the handle.

4. The dispenser according to claim 1, comprising a scraping portion, wherein the scraping portion is provided at an edge facing the opening portion of the cover plate and being configured to perform scraping of the upper end opening of the accommodating cylinder.

5. The dispenser according to claim 4, wherein the scraping portion is provided so as to have a predetermined height by extending the edge facing the opening portion of the cover plate in a downward direction and has a deflating shape with an inner width reduced toward a rotating direction of the accommodating portion.

6. The dispenser according to claim 2, comprising an agitator, wherein
the agitator includes:
a center portion that receives transmission of the rotational force of the axis body portion; and
a first agitating vane extending from the center portion outwardly in a radial direction and disposed along an inner surface of the storage container and a second agitating vane thicker in width and shorter than the first agitating vane.

7. The dispenser according to claim 6, wherein
the first agitating vane comprises a first horizontal agitating portion extending from the center portion horizontally, outwardly in the radial direction and an upper agitating portion extending from an outer end of the first horizontal agitating portion upwardly along the inner surface of the storage container, and
the second agitating vane comprises a second horizontal agitating portion extending from the center portion horizontally, outwardly in the radial direction.

8. The dispenser according to claim 1, wherein in the accommodating cylinder, an inner width in a direction orthogonal to an extending direction of the accommodating cylinder increases from the upper end opening toward the lower end opening.
